(19) United States
(12) Patent Application Publication
(10) Pub. No.: US 2015/0334921 A1
(43) Pub. Date: Nov. 26, 2015

(54) APPARATUS AND METHODS FOR CONTAINING BALES ON A TRANSPORT VEHICLE

(71) Applicant: Vermeer Manufacturing Company, Pella, IA (US)

(72) Inventors: David Jahraus, Pella, IA (US); Lucas Graham, New Sharon, IA (US); Seth Schreur, Pella, IA (US); Todd Carroll, Ottumwa, IA (US); Scott Weishaar, Sioux Falls, SD (US); Travis Koster, Pleasant Hill, IA (US); Luke A. Mushitz, Yankton, SD (US); Corbin Fehr, Morris, MN (US)

(73) Assignee: Vermeer Manufacturing Company, Pella, IA (US)

(21) Appl. No.: 14/445,236

(22) Filed: Jul. 29, 2014

Related U.S. Application Data
(60) Provisional application No. 62/002,369, filed on May 23, 2014.

(51) Int. Cl. A01D 90/08

(52) U.S. Cl. CPC A01D 90/083

(57) ABSTRACT

Apparatus and methods for securing bales on a transport vehicle are disclosed. The apparatus may include containment arms that extend between bales for containing movement of the bales during transport.

### CROSS-REFERENCE TO RELATED APPLICATION

This application claims the benefit of U.S. Provisional Application No. 62/002,369 filed May 23, 2014, which is incorporated herein by reference.

### FIELD OF THE DISCLOSURE

The field of the disclosure relates to apparatus and methods for containing bales on a transport vehicle.

### BACKGROUND

Crop material such as hay (e.g., alfalfa and/or grass hay), corn stover, silage and energy crops (e.g., various grasses) are periodically cut in the field and compacted into bales for transport and storage of the forage material. Recent evolutions in row crop production and in technology for processing these materials have led to changes in the scale and economics of harvest.

Increase in scale of livestock, biofuel and other bio-based operations require forage and other biomass materials to be transported over longer distances, often on flatbed semi-trailers. Such transport conventionally requires use of multiple straps thrown over the load to secure the bales. The hauler must secure each strap to one side of the trailer, toss each strap over the load of bales, align and secure each strap at the opposite side of the trailer and tighten each strap.

Securing the load by straps is time-consuming for the hauler. Further, the hauler must occasionally climb the load of bales to secure a strap that was not fully tossed over the load of bales and/or to properly align a strap. Climbing the load of bales may be difficult for the hauler and also is hazardous due to potential falls.

A continuing need exists for an apparatus for containing bales on a transport vehicle that allows the bales to be loaded relatively quickly and reliably, and that allows the bales to be safely contained for transport in a way that minimizes demands on the hauler and that complies with various highway transport standards. A need also exists for methods for gathering bales that use such apparatus.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to an apparatus for containing bales on a transport vehicle comprising a bed deck. The apparatus has a longitudinal axis and includes a retainer frame having containment arms for extending between bales to contain movement of the bales in the direction of the longitudinal axis. The apparatus includes support legs that extend upward from the bed deck for supporting the retainer frame above the bed deck. The apparatus also includes a retainer frame actuator operatively connected to a support leg for raising the retainer frame for loading bales on the bed deck in one or more rows and thereafter lowering the frame to contain bales.

Another aspect of the present disclosure is directed to a method for loading bales on a transport vehicle having a bed deck. The transport vehicle has a bale containment apparatus attached thereto. The bale containment apparatus has a longitudinal axis and comprises a retainer frame for containing movement of the bales along the longitudinal axis and support legs that extend upward from the bed deck for supporting the retainer frame above the bed deck. The retainer frame is raised to a loading position by increasing the distance between the retainer frame and the bed deck. Bales are loaded onto the bed deck. The retainer frame is lowered to a travel position such that containment arms of the retainer frame extend between bales to contain movement of the bales along the longitudinal axis.

A further aspect of the present disclosure is directed to an apparatus for securing bales on a transport vehicle having a bed deck. The apparatus has a longitudinal axis. The apparatus includes a retainer frame for overlying and containing the bales. Support legs extend upward from a central portion of the bed deck for supporting the retainer frame above the bed deck. A retainer frame actuator is operatively connected to a support leg for raising the retainer frame for loading bales on the bed deck and thereafter lowering the frame to secure and contain the bales positioned on the bed deck.

Yet another aspect of the present disclosure is directed to a method for loading bales on a transport vehicle having a bed deck. The transport vehicle has a bale securing apparatus attached thereto. The bale securing apparatus has a longitudinal axis and includes a retainer frame for overlying and containing the bales and support legs that extend upward from the bed deck for supporting the retainer frame above the bed deck. The retainer frame is raised generally vertically to a loading position by increasing the distance between the retainer frame and the bed deck. Bales are loaded onto the bed deck. The retainer frame is lowered generally vertically to a travel position by decreasing the distance between the retainer frame and the bed deck to secure bales positioned on the bed deck.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of the apparatus for containing bales in a loading position and a pulling vehicle;

FIGS. 2-4 are perspective views of separate modules of the apparatus and pulling vehicle;

FIG. 5 is a rear view of the apparatus and pulling vehicle;

FIG. 6 is a detailed perspective view of a first gate of the apparatus and pulling vehicle;

FIG. 7 is a detailed perspective view of a second embodiment of the first gate of the apparatus;

FIG. 8 is a detailed perspective view of the retainer frame actuator for raising the retainer frame;

FIGS. 9-10 are detailed perspective views of the apparatus and pulling vehicle;

FIG. 11 is a detailed perspective view of the gate assembly actuator for extending the gate assembly;

FIG. 12 is a perspective view of the apparatus loaded with bales in a loading position and a pulling vehicle;

FIG. 13 is a perspective view of the apparatus loaded with bales in a transport position and a pulling vehicle;

FIG. 14 is a side view of a second embodiment of the apparatus for containing bales and a pulling vehicle;

FIG. 15 is a perspective view of the second embodiment of the apparatus and pulling vehicle;

FIG. 16 is a rear view of the second embodiment of the apparatus and pulling vehicle;

FIG. 17 is a side view of a support leg, retainer frame and retainer frame actuator for raising the retainer frame of the apparatus of FIG. 14;

FIG. 18 is a perspective view of the retainer frame of the apparatus of FIG. 14;

FIG. 19 is a rear view of the gate assembly and gate assembly actuator for extending the gate assembly of the apparatus of FIG. 14;

FIG. 20 is a perspective view of an elongate support member and cross member of the apparatus of FIG. 14;

FIG. 21 is a perspective view of the second embodiment of the apparatus in a loading position and a pulling vehicle;

FIG. 22 is a rear view of the second embodiment of the apparatus in a loading position and a pulling vehicle;

FIG. 23 is a perspective view of the second embodiment of the apparatus loaded with bales in a transport position and a pulling vehicle;

FIG. 24 is a rear view of the second embodiment of the apparatus loaded with bales in a transport position and a pulling vehicle; and

FIG. 25 is a perspective view of a third embodiment of the apparatus with a retainer frame having end members loaded with bales in a transport position and a pulling vehicle.

Corresponding reference characters indicate corresponding parts throughout the drawings.

### DETAILED DESCRIPTION

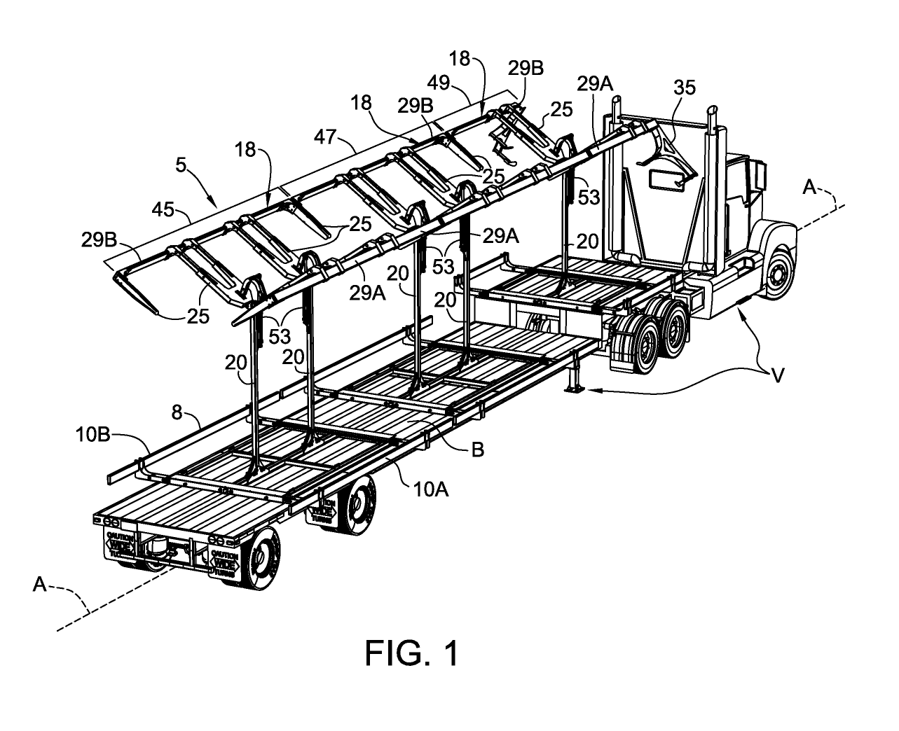

An embodiment of an apparatus for containing bales is generally referred to as “5” in FIG. 1. The apparatus 5 is shown attached to a bed deck B of a transport vehicle V. The vehicle V is illustrated to show use of the bale-securing apparatus 5 and does not form part of the apparatus. Generally, the vehicle V is suitable for transporting bales within a farm operation or over a primary or secondary road system. Suitable vehicles include, for example, semi-trailers, straight-trucks, railcars, in-field and/or highway bale movers, 5^{th} wheel or towable trailers (e.g., pickup trailers such as ball hitch or pintle hitch trailer) and the like. Generally, the transport vehicle V has a bed deck B upon which bales may be set for transport.

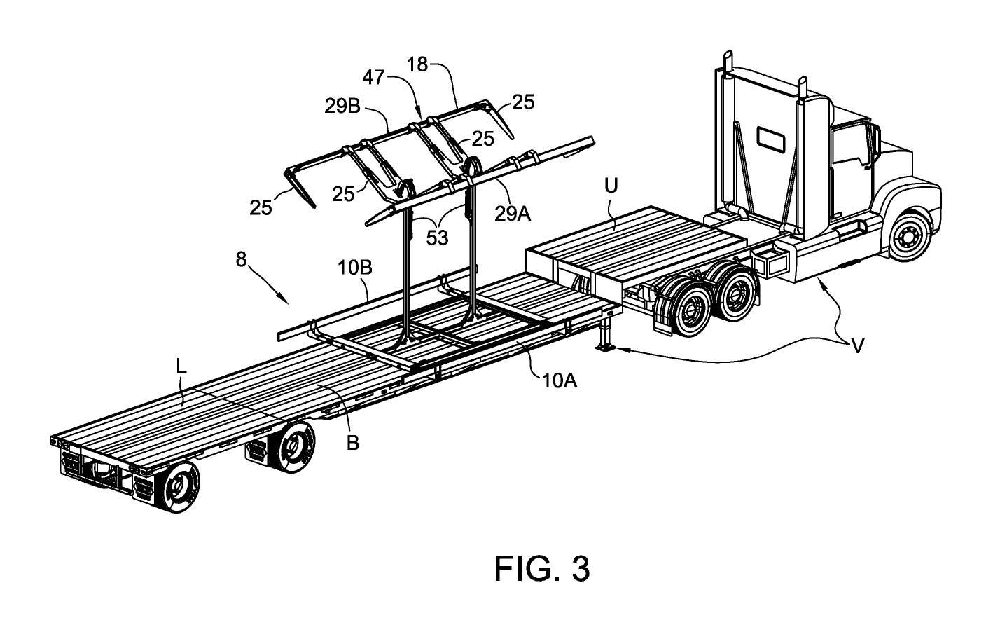

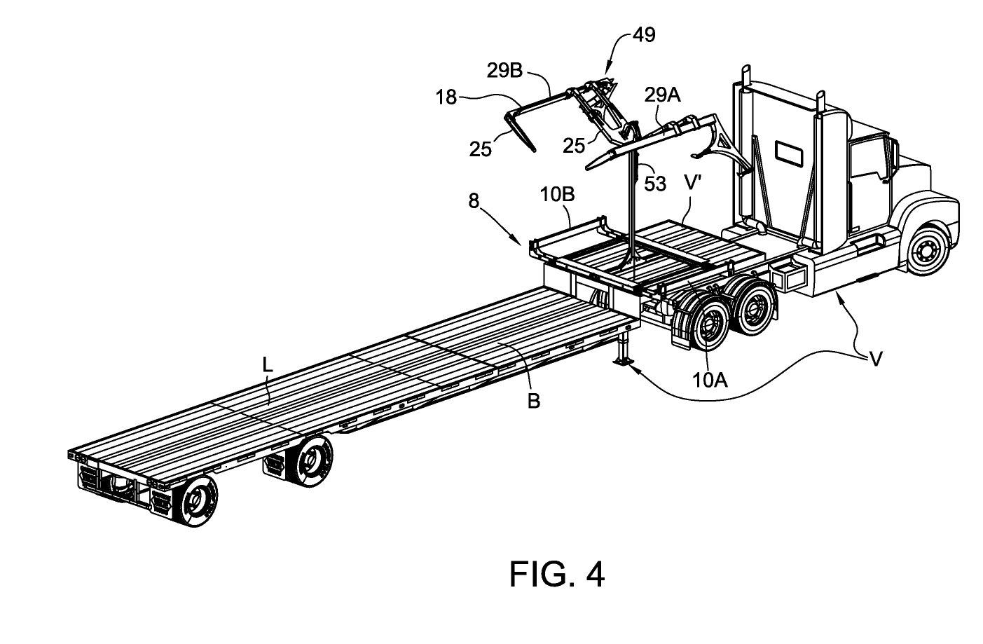

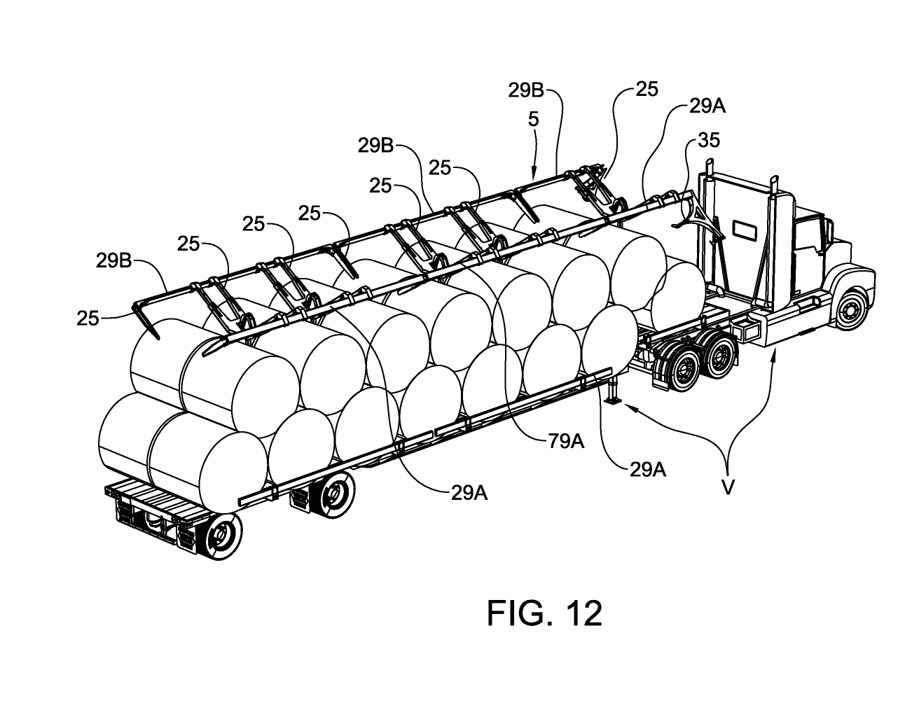

The apparatus 5 is generally longitudinally symmetrical (i.e., relative to the longitudinal axis A) in that several components have a corresponding component with the same function opposite the component (i.e., across the bed deck B). Corresponding components of the pair may be indicated herein by use of a reference number followed by “A” and “B” and may be referred to as a “first” component and a “second” component, respectively. While the apparatus 5 may be described herein with reference to the components of one side of the apparatus 5, any component designated by “A” or “B” herein or shown in FIGS. 1-25 includes a corresponding component with the same function opposite the component.

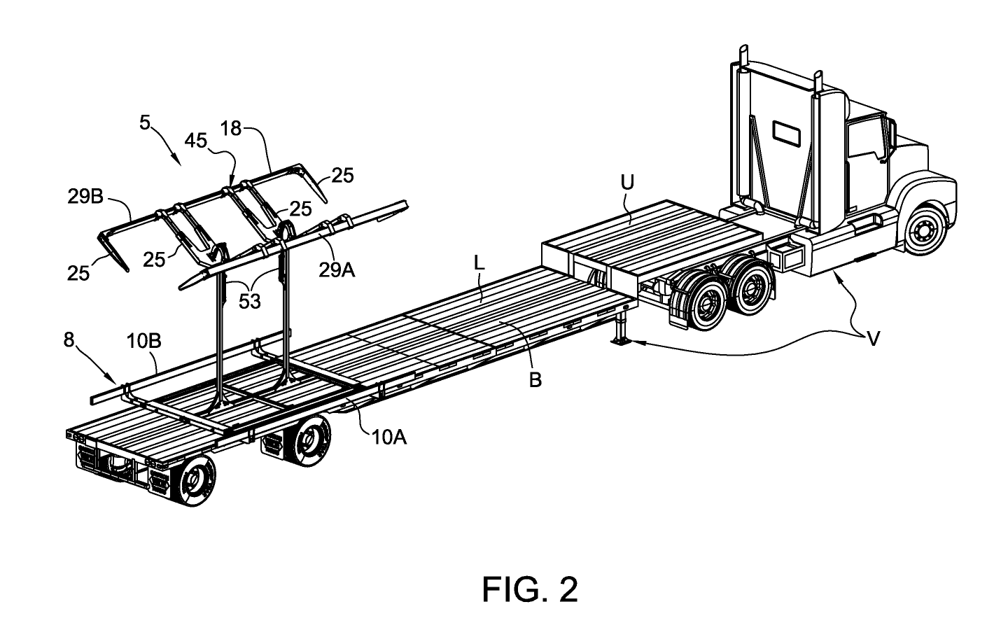

The apparatus 5 includes a longitudinal axis A that is parallel to the direction of travel of the transport vehicle V (i.e., parallel to its length). The apparatus 5 includes three modules 45, 47, 49 (shown in FIGS. 2-4, respectively, with the other modules not being shown) for containing bales during transport. As used herein, the term “module” refers to separate units that may be separately attached to the pulling vehicle.

As shown in the FIGS. 2-4, the pulling vehicle V includes a “drop-deck” type trailer having an upper deck U and lower deck L. Modules 45, 47 are attached to the lower deck L and module 49 is attached to the upper deck U.

Each module 45, 47, 49 includes a gate assembly 8 that extends along the bed deck B parallel to the longitudinal axis for containing bales. The gate assembly 8 includes a first gate 10A and a second gate 10B positioned across the bed deck B opposite the first gate 10A.

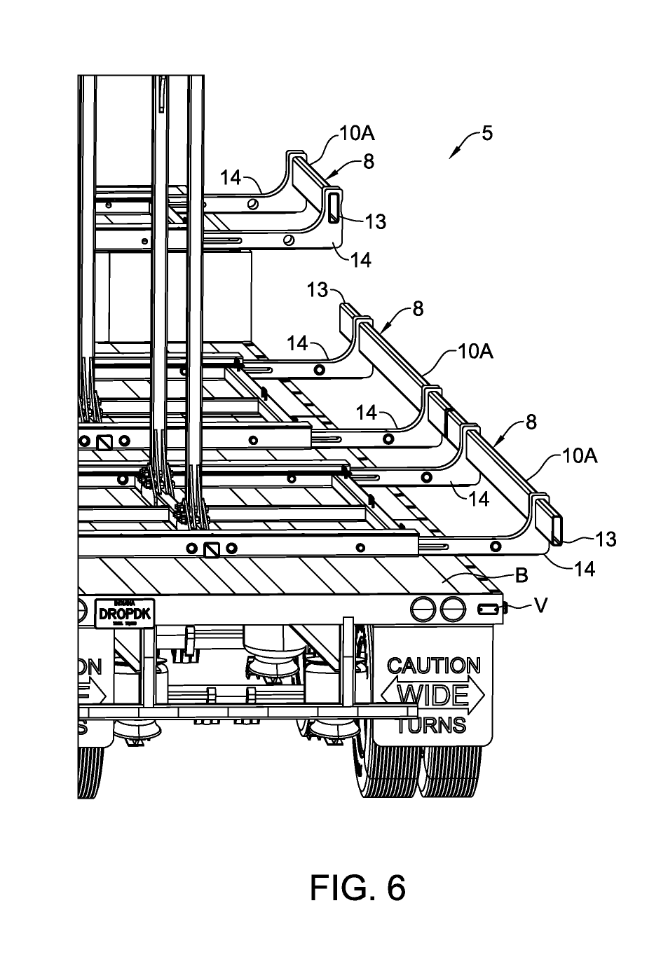

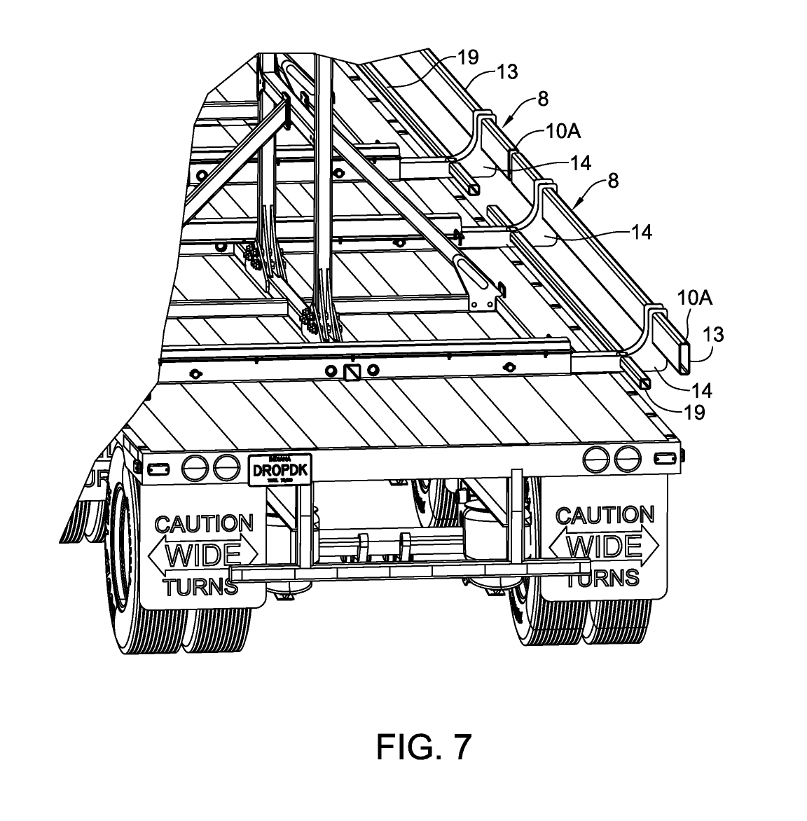

Each gate 10A, 10B includes a gate rail 13 and telescoping legs 14 (FIG. 6). The rails 13 may be used to assist in loading bales. Bales are loaded over the rail and onto the bed deck B by use of a bale loader (e.g., tractor loader, skid steer and the like). As the loader is backed away from the pulling vehicle V, the rails 13 may be used as a bale brace to allow the bale to disengage from the forks of the bale loader. As shown in FIG. 7, the gates 10A, 10B may also include a second rail 19 which may support the bale during loading (i.e., keep the bales aligned vertically by preventing the bales from dipping downward beyond the bed deck B during loading). The second rail 19 is generally vertically lower than the first rail 13. The second rail is generally aligned with the bed deck B to support bales and the first rail is generally vertically higher to contain the bale in a direction transverse to the longitudinal axis A of the bed deck B.

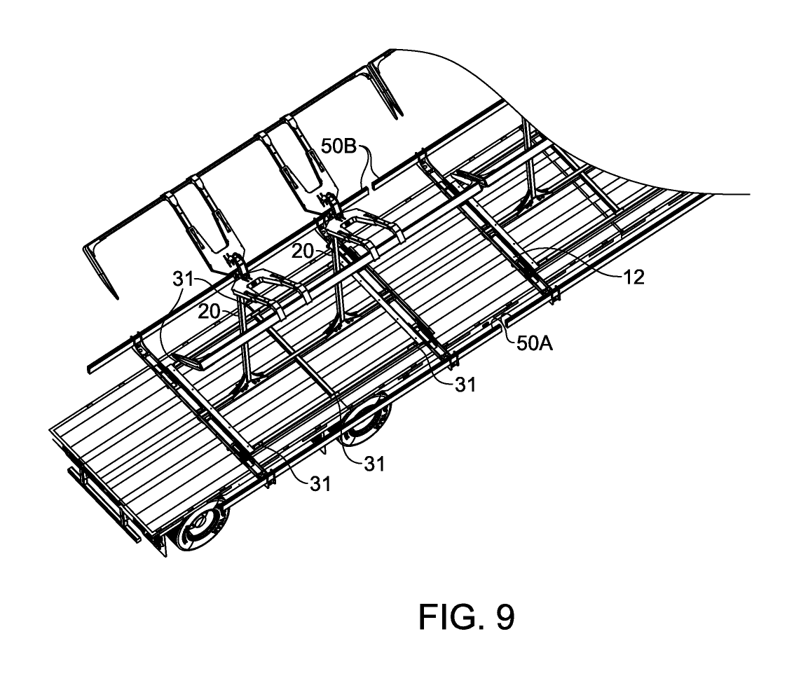

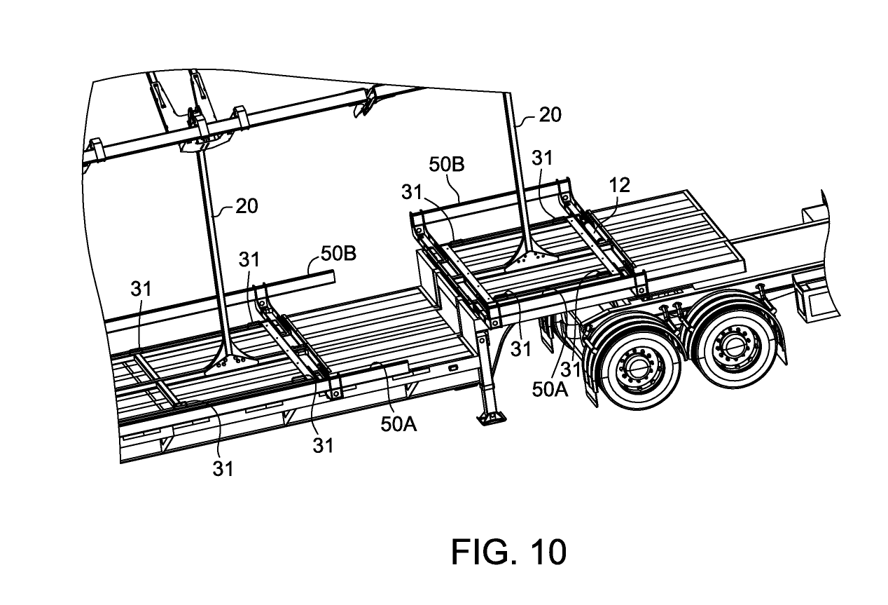

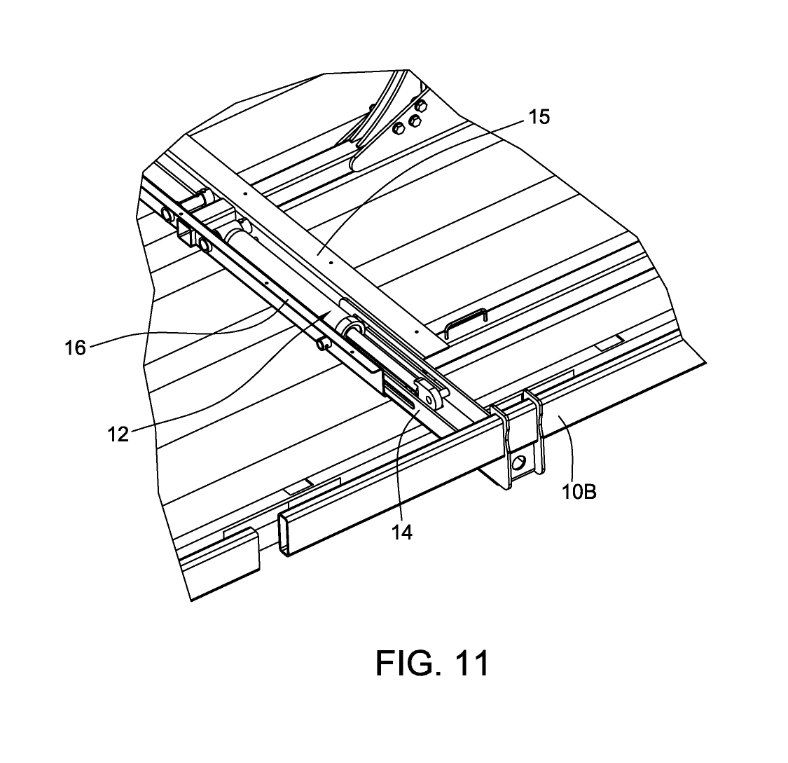

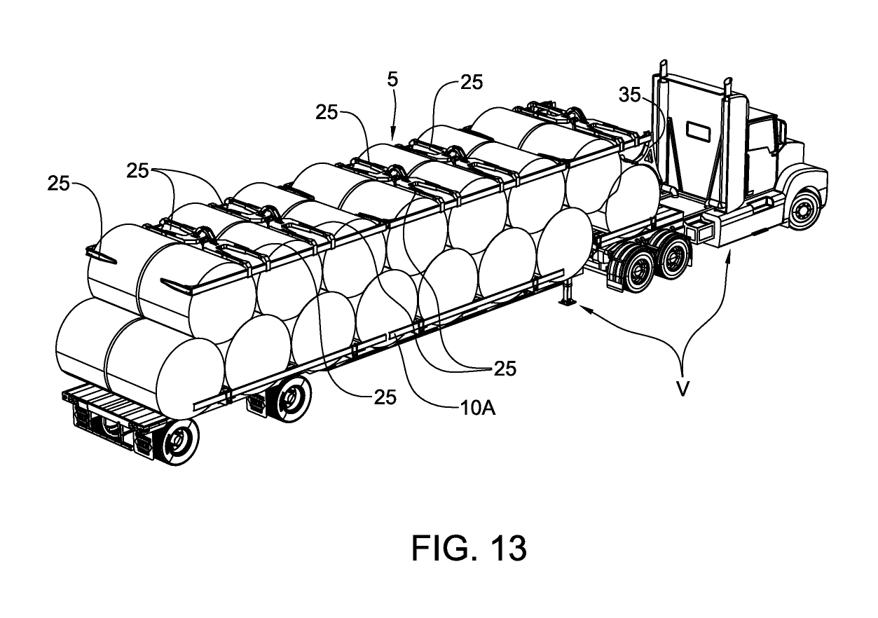

Each module 45, 47, 49 includes a gate assembly actuator 12 (FIGS. 9-10; cover plates not shown) for reducing a width of the gate assembly 8 to comply with highway transport standards and to contain bales positioned on the bed deck B. Each actuator 12 is operative connected to a telescoping leg 14 (FIG. 11) and sleeve 16. The telescoping leg 14 is movable within the sleeve 16 to facilitate actuation of the gate assembly 8. Upon loading bales onto the bed deck B, the actuators 12 are actuated to reduce the width of the gate assembly 8 (i.e., the distance between first and second gates 10A, 10B) and cause the gates 10A, 10B to approach the bales to sufficiently contain the bales proximate the bed deck B during bale transport (FIG. 13). In some embodiments, the gates 10A, 10B contact the loaded bales and secure the bales for transport. In other embodiments, the gates 10A, 10B do not contact the loaded bales but merely contain them during transport. Gates 10A, 10B may be any retainer element capable of containing movement of the bales such as tubes, planks, boards or chains.

Generally, each module 45, 47, 49 includes at least two gate assembly actuators 12 with a first actuator attached to the first gate 10A and a second actuator attached to the second gate 10B. More or less actuators 12 may be used to extend and retract the gates. In other embodiments, rather than using actuators 12 on both sides of the apparatus, one gate is fixed and the other gate is extended by a series of actuators attached to the gate.

As shown in the Figures, the actuators 12 are hydraulic cylinders. The actuators 12 may be part of a hydraulic circuit for controlling the cylinders. Any hydraulic system available for use in transport vehicles may be used to drive the cylinders. In some embodiments, the hydraulic system includes a hydraulic pump (not shown) that may be driven by a power-take-off (PTO) of the transport vehicle (i.e., as part of a wetline kit) or may be driven by a power unit mounted to the trailer. In other embodiments, the actuators 12 are pneumatic or electrically driven. Pneumatic systems may be connected to the air system of the pulling vehicle and, optionally, may include additional air tanks mounted to the trailer.

Each module 45, 47, 49 of the bale-securing apparatus 5 includes a retainer frame 18 (FIGS. 2-4) that extends above the bed deck B parallel to the longitudinal axis of the apparatus for containing bales loaded on the bed deck B. Support legs 20 (FIG. 1) extend from a central portion of the bed deck B and support the retainer frames 18. In the illustrated embodiment, four of the support legs 20 are sized to contain bales loaded on the lower deck L of the pulling vehicle V and one leg 20 is sized to contain bales loaded on the upper deck U (i.e., the legs are sized such that the retainer frames 18 of each module 45, 47, 49 are aligned).

The retainer frame 18 of each module 45, 47, 49 includes containment arms 25. Upon lowering the retainer frame 18 (FIG. 13), the containment arms 25 extend between bales to contain movement of each bale in the direction of the longitudinal axis A (i.e., limiting bale movement within the bed deck). The arms also contain movement of the bales vertically. A portion of the containment arms 25 are pivotally connected to support legs 20 (FIGS. 2-4) to suspend the retainer frame 18. In other embodiments (not shown), arms 25 do not extend between each depression formed by the bales; rather, a group of bales is contained by arms 25.

The containment arms 25 of each module 45, 47, 49 are attached to elongate end members 29A, 29B. The elongate end members 29A, 29B contain movement of the bales in a direction transverse to the longitudinal axis A. The retainer frame 18 also includes two forward containment elements 35 (FIG. 1) that each include a curved portion that is sized and shaped to mate with a radial portion of a bale surface. The forward containment elements 35 are positioned and arranged to contain the bales loaded nearest the front of the pulling vehicle V on the upper deck U of the bed deck B.

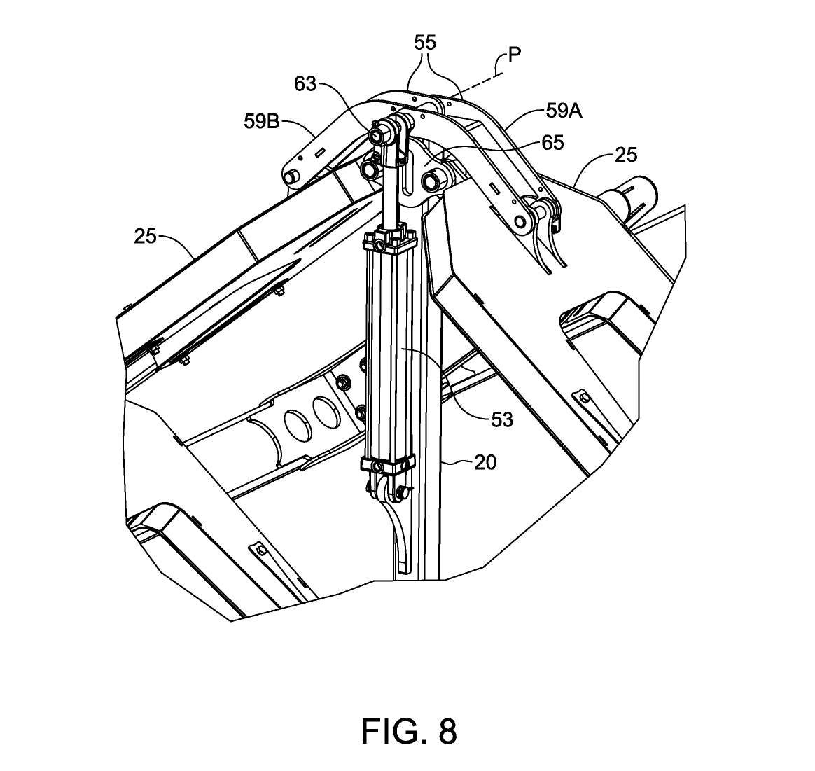

Each module 45, 47, 49 includes a retainer frame actuator 53 for raising the retainer frame 18 for loading bales on the bed deck B and thereafter lowering the frame to contain bales positioned on the bed deck B. Referring now to FIG. 8, the retainer frame actuator 53 is attached to a support leg 20 and pivot pin 63. The pivot bracket 55 includes two legs 59A, 59B connected to the pivot pin 63. Each leg 59A, 59B pivots about pivot axis P which extends through the pin. Each pivot bracket leg 59A, 59B is pivotally attached to a containment arm 25. Mounting bracket 65 also secures the containment arms 25 to the support leg 20.

The retainer frame actuator 53 is powered for raising the retainer frame 18 for loading bales on the bed deck. The retainer frame 18 may be lowered by gravity or the retainer frame actuator may also be powered for lowering the retainer frame 18 to secure and contain the bales positioned on the bed deck B. During loading of bales on the transport vehicle V, the retainer frame actuators 53 are extended to cause the arms to swing up to increase the clearance between the bed deck B and the retainer frame 18. As shown in FIG. 13, after the bales are loaded on the transport vehicle, the retainer frame 18 is pivoted downward to reduce the distance between the bed deck B and the retainer frame 18 to contain the bales.

The retainer frame 18 may be sized and shaped to limit movement of the upper rows of bales. As shown in FIG. 13, the containment arms 25 extend within the depression formed between two bales, and the elongate end members 29A, 29B extend beyond and alongside the ends of a number of bales. In some embodiments, the retainer frame 18 does not contact the bales after loading and limits movement of the bales during transport. While the retainer frame 18 is operable for limiting the movement of round bales, the retainer frame 18 may also be used for securing bales of other shapes (e.g., small or large square bales). In some embodiments, the retainer frame 18 is sized and shaped for a particular size of round bale (e.g., 4 foot wide×5 foot diameter or 5 foot wide×6 foot diameter). However, the apparatus 5 should not be considered to be limited to a particular size or shape of bale unless stated otherwise.

As shown in the Figures, the retainer frame actuators 53 are hydraulic cylinders. Other types of actuators may be used in other embodiments (e.g., rack and pinion actuators). The retainer frame actuator may form part of a hydraulic circuit. Such circuits may include a hydraulic pump as described above in relation to the gate assembly actuators 12.

Bale chocks may be used at the rear and/or front of the apparatus 5 to prevent the load of bales from moving forward or backward. Alternatively or in addition, the apparatus 5 may include front and/or rear safety bars (not shown) to contain bales on one or more rows stacked on the bed deck.

Generally, the apparatus 5 is removably attached to the bed deck B of the transport vehicle V to allow the bed deck B to be used for purposes other than transporting bales. As shown in FIGS. 9-10, each module includes strap guides 31 for strapping the module to the bed deck B. The strap guides 31 are paired with the two strap guides 31 being opposite each other across the bed deck B. In other embodiments, the modules 45, 47, 49 are bolted to the bed deck B. In yet other embodiments, rather than being removably attached to the transport vehicle V, the apparatus 5 is integral with the bed deck B.

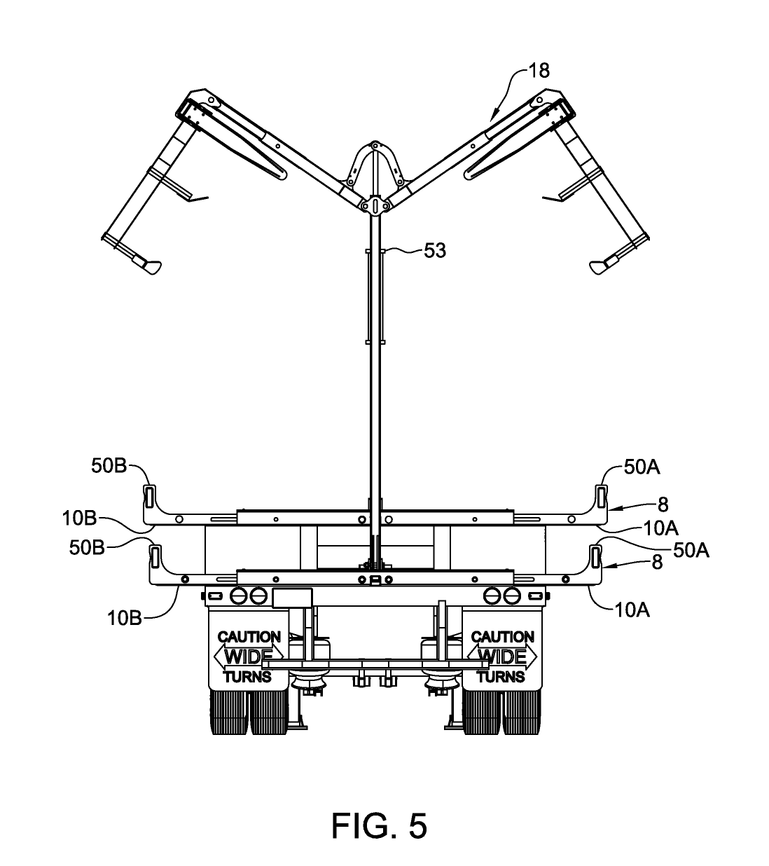

To load and contain bales on the bed deck B, the gate assembly 8 and retainer frame 18 of the apparatus 5 are extended to a loading position (FIGS. 1-6). In the loading position, the gates 10A, 10B are extended to increase the distance between the gates to facilitate loading of bales onto the bed deck B. Additionally, the retainer frame 18 is pivoted upward from the bed deck B to increase the clearance between the retainer frame 18 and the top 50A, 50B (FIG. 5) of the gates 10A, 10B over which the bales are loaded.

After the bales are loaded in one or more rows on the bed deck B, the gates 10A, 10B are retracted by use of the gate assembly actuators 12 to a transport position (FIG. 13) to contain the bales. In the transport position, the gates 10A, 10B are nearer to (and possibly contact) the bales to prevent them from moving in a direction transverse to the longitudinal axis A. Additionally, the retainer frame 18 is pivoted downward by use of retainer frame actuators 53. Upon lowering, the containment arms 25 extend between bales to limit movement of the bales in the direction of the longitudinal axis, and end members 29A, 29B extend beyond and alongside the ends of a set of bales to limit the movement of the bales in the direction transverse to the axis.

To unload bales, the gates 10A, 10B and retainer frame 18 are extended to an unloading position. Generally, the unloading position corresponds to the loading position (FIGS. 1-6).

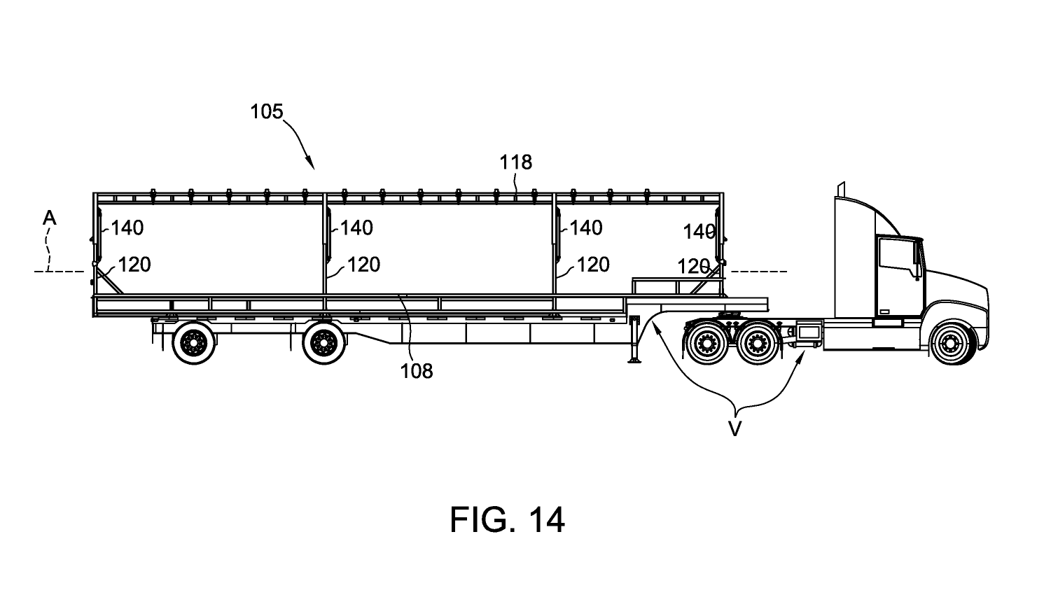

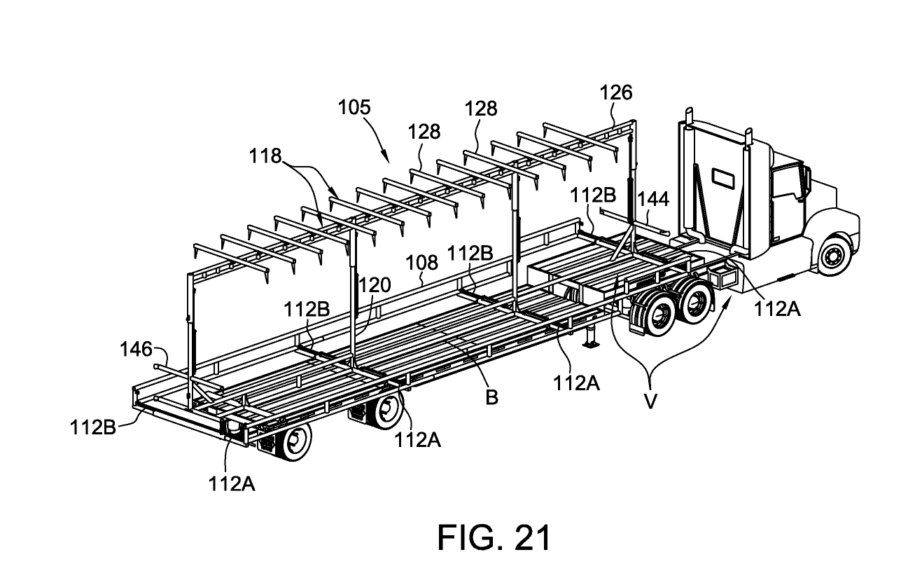

A second embodiment of an apparatus for containing bales is generally referred to as “105” in FIG. 14. It should be noted that the bale-containing apparatus components shown in FIGS. 14-24 that are analogous to those of FIGS. 1-13 are designated by the corresponding reference number of FIGS. 1-13 plus “100” (e.g., part 15 becomes part 115). The apparatus 105 is also shown attached to a bed deck B (FIG. 21) of a transport vehicle V.

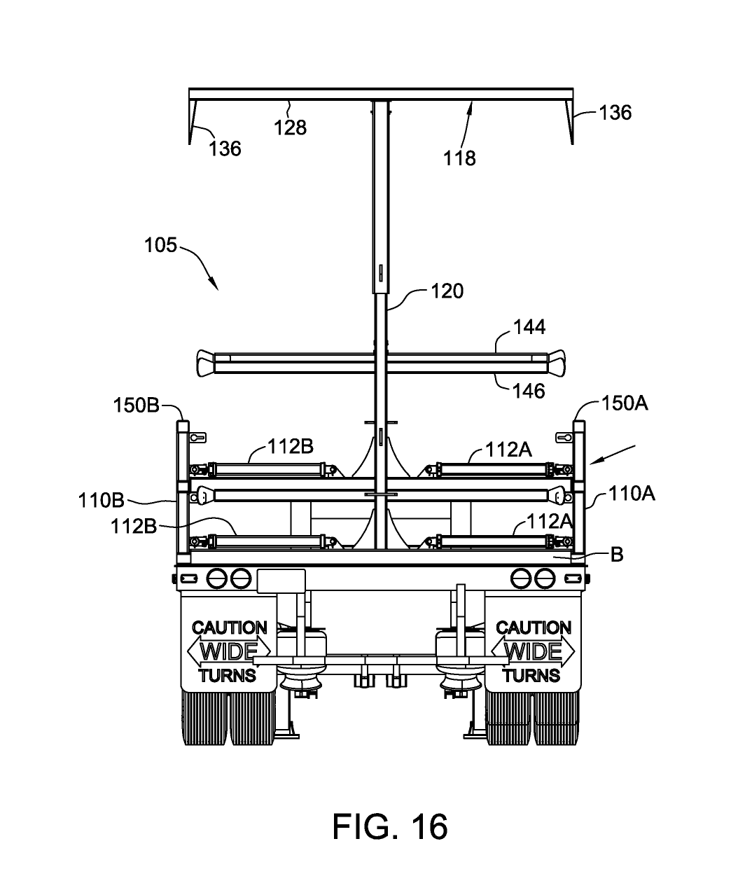

The apparatus 105 includes a gate assembly 108 that extends along the bed deck B parallel to the longitudinal axis for securing and containing bales. With reference to FIG. 16, the gate assembly 108 includes a first gate 110A and a second gate 110B positioned across the bed deck B opposite the first gate 110A.

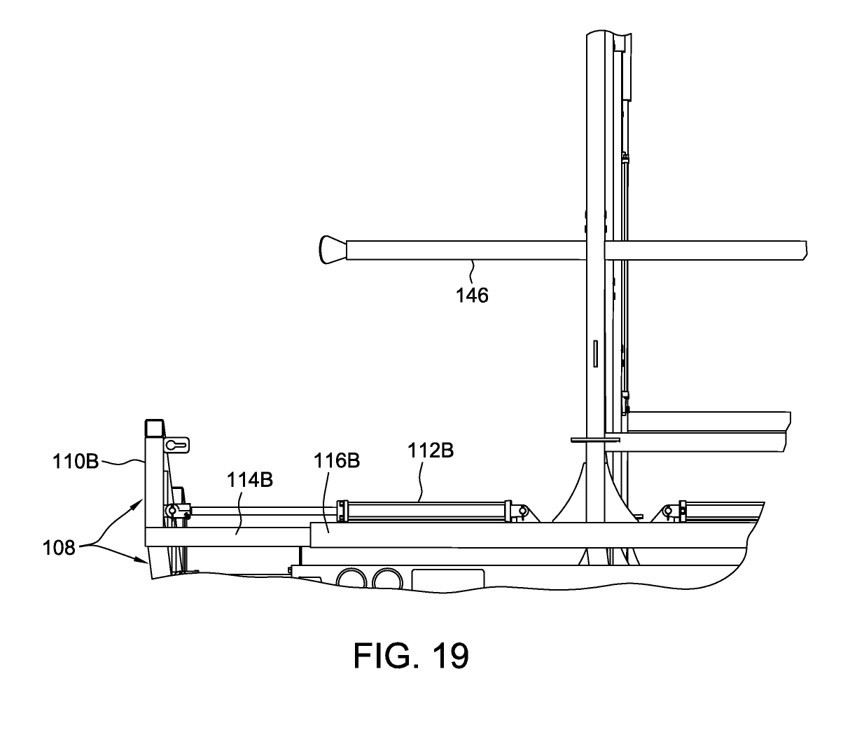

The apparatus 105 includes first gate assembly actuators 112A (FIG. 16) and second gate assembly actuators 112B. The gate assembly actuators 112A, 112B are operatively connected to the first gate 110A and second gate 110B, respectively. With reference to FIG. 19, each side of the gate assembly 108 includes a telescoping leg 114B that is movable within a sleeve 116B to facilitate actuation of the gate assembly.

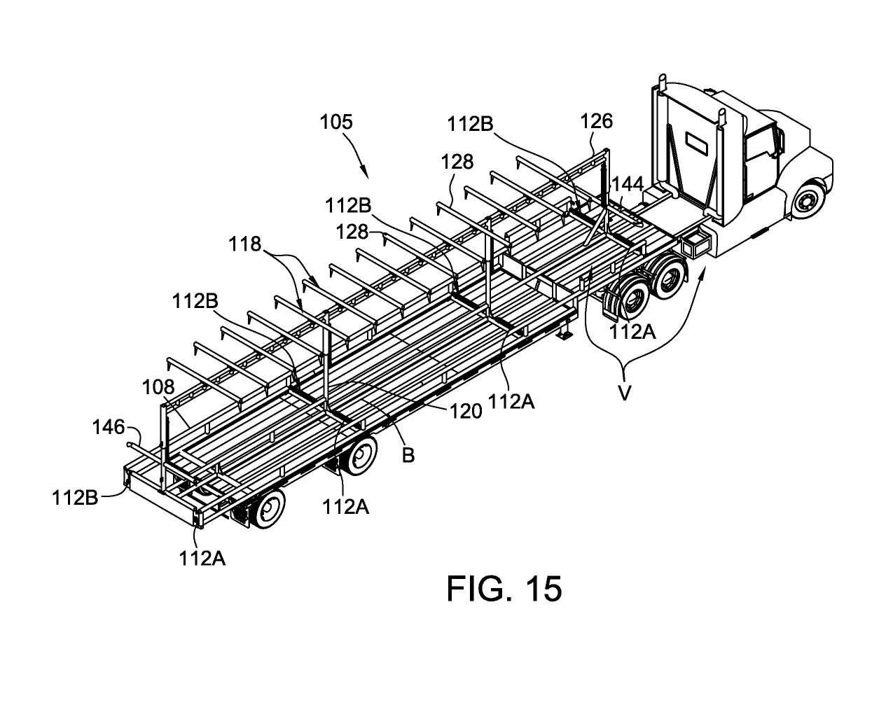

Referring now to FIG. 15, the apparatus 105 includes a total of eight actuators 112A, 112B to extend the gates 110A, 110B. More or fewer actuators 112A, 112B may be used to extend and retract the gates. In other embodiments, rather than using actuators 112A, 112B on both sides of the apparatus, one gate is fixed and the other gate is extended by a series of actuators attached to the gate.

As shown in the Figures, the first and second actuators 112A, 112B are hydraulic cylinders. The gate assembly actuators 112A, 112B may form part of a hydraulic circuit for controlling the cylinders, as described above in regard to apparatus 5.

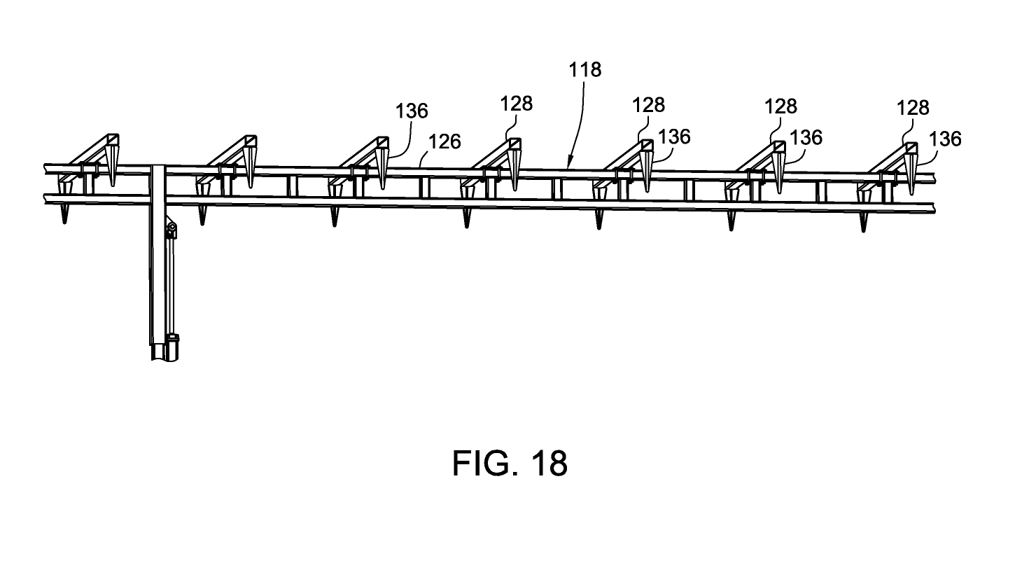

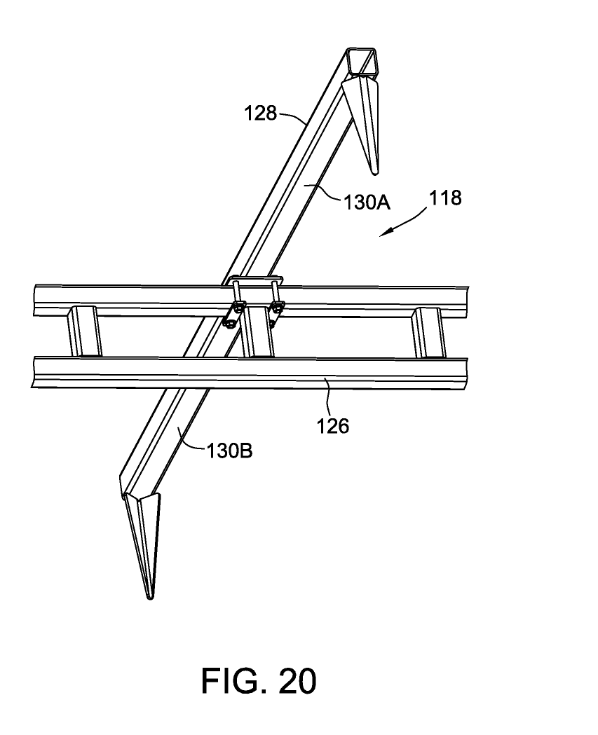

Support legs 120 (FIG. 14) extend from a central portion of the bed deck B and support a retainer frame 118. The retainer frame 118 includes an elongate support member 126 (FIG. 18) that extends the length of the bed deck and cross members 128 that extend orthogonally from the support member. In some other embodiments, the support member 126 is separated into two or more modules. Each cross member 128 may include two bale-engaging surfaces 130A, 130B (FIG. 20) that contain and, as in some embodiments, contact the bales upon lowering of the retainer frame 118.

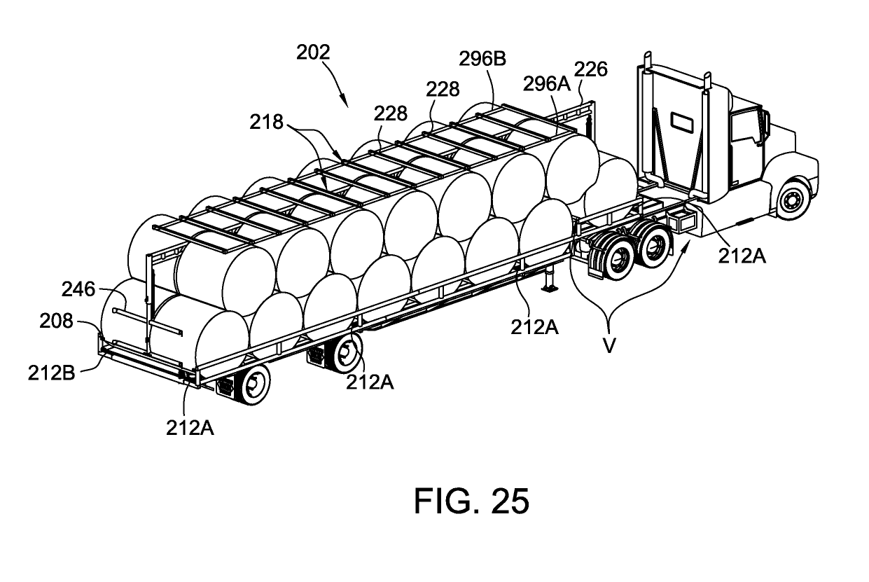

In the illustrated embodiment, a barb 136 is attached to each end of the cross member 128. Upon lowering the retainer frame 118, the barb 136 pierces a bale to secure the stack of bales. In some embodiments, the retainer frame 118 does not include barbs and the bales are secured by down-force of the cross members 128 or by other suitable methods. In some embodiments, an upper gate assembly (not shown) extends downward from the cross-members 128 to contain movement of bales in a direction orthogonal to the longitudinal axis A during transport. In another embodiment, the retainer frame 218 of the apparatus 202 includes end members 296A, 296B (FIG. 25) to contain the bales.

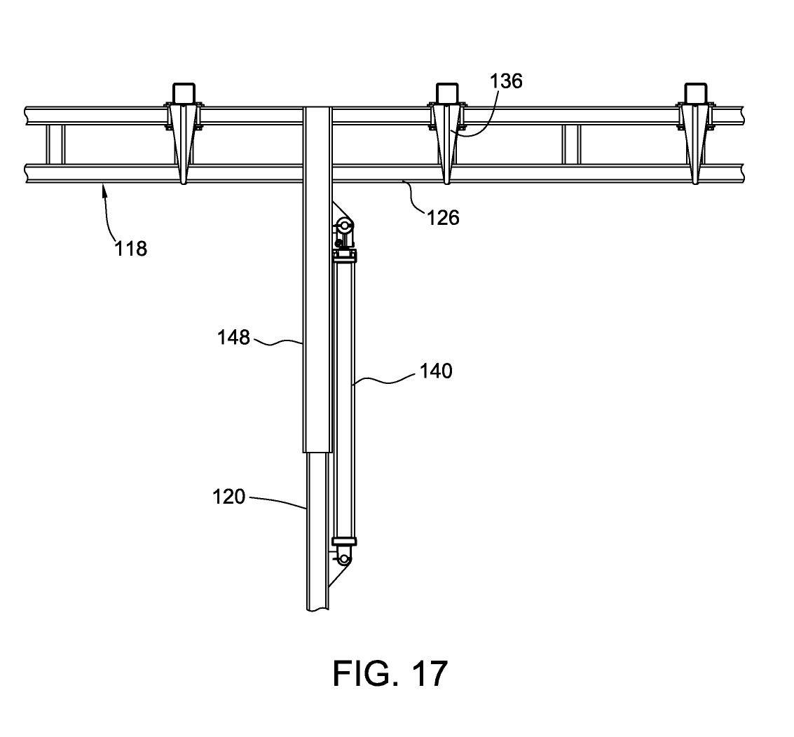

The apparatus 105 includes retainer frame actuators 140 (FIG. 17) for raising the retainer frame 118 for loading bales on the bed deck B and thereafter lowering the frame to secure and contain bales positioned on the bed deck B. The retainer frame actuators 140 are operatively connected to a corresponding support leg 120. Each support leg 120 includes a telescoping portion 148 that allows the distance between the retainer frame 118 and the bed deck B to be changed by use of actuators 140.

The retainer frame actuators 140 are powered for raising the retainer frame 118 for loading bales on the bed deck. The retainer frame 118 may be lowered by gravity, or the retainer frame actuators 140 may also be powered for lowering the retainer frame 118 to secure and contain the bales positioned on the bed deck B. The retainer frame 18 may be securely fastened in the travel position by use of chains, latches or the like during transport.

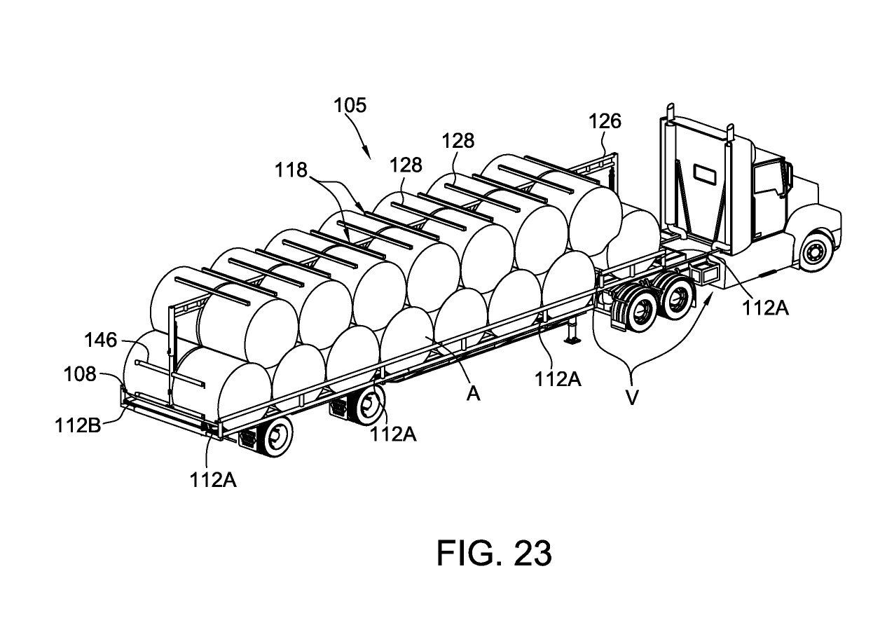

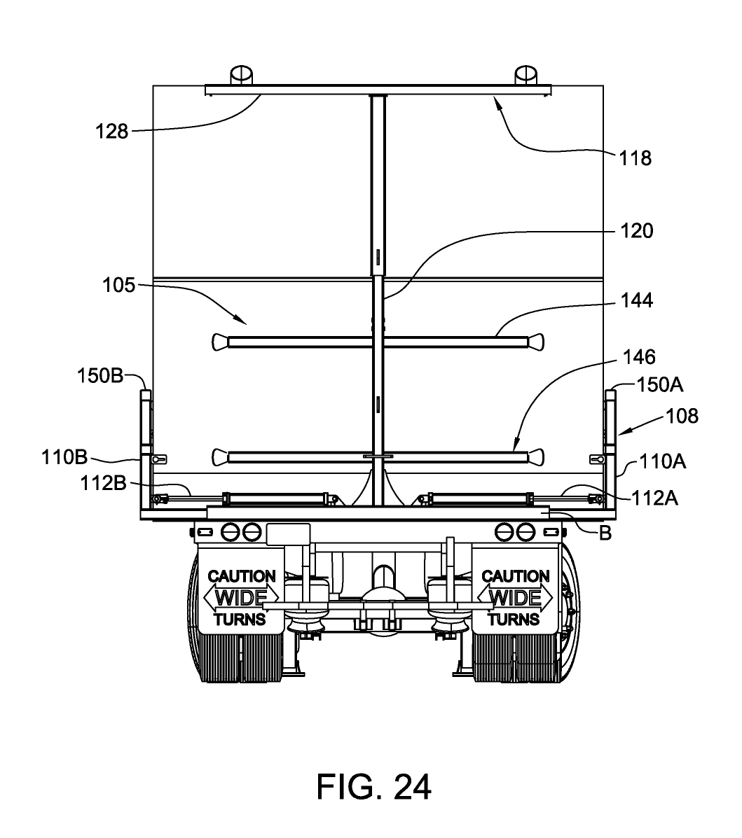

During loading of bales on the transport vehicle V, the retainer frame actuators 140 are extended to increase the clearance between the bed deck B (FIG. 15) and the retainer frame 118. As shown in FIGS. 23-24, after bales are loaded on the transport vehicle, the retainer frame 118 is lowered to reduce the length of the support leg 120 by collapsing the telescoping portion 148 to reduce the distance between the bed deck B and the retainer frame 118 to secure and/or contain the bales. The retainer frame actuators 140 are adapted to non-pivotally actuate the retainer frame 118.

As shown in the Figures, the retainer frame actuators 140 are hydraulic cylinders. Other types of actuators may be used in other embodiments. The retainer frame actuators may form part of a hydraulic circuit that includes a hydraulic pump.

The apparatus 105 also includes front and rear safety bars 144, 146 (FIG. 15) to secure bales on one or more rows stacked on the bed deck B.

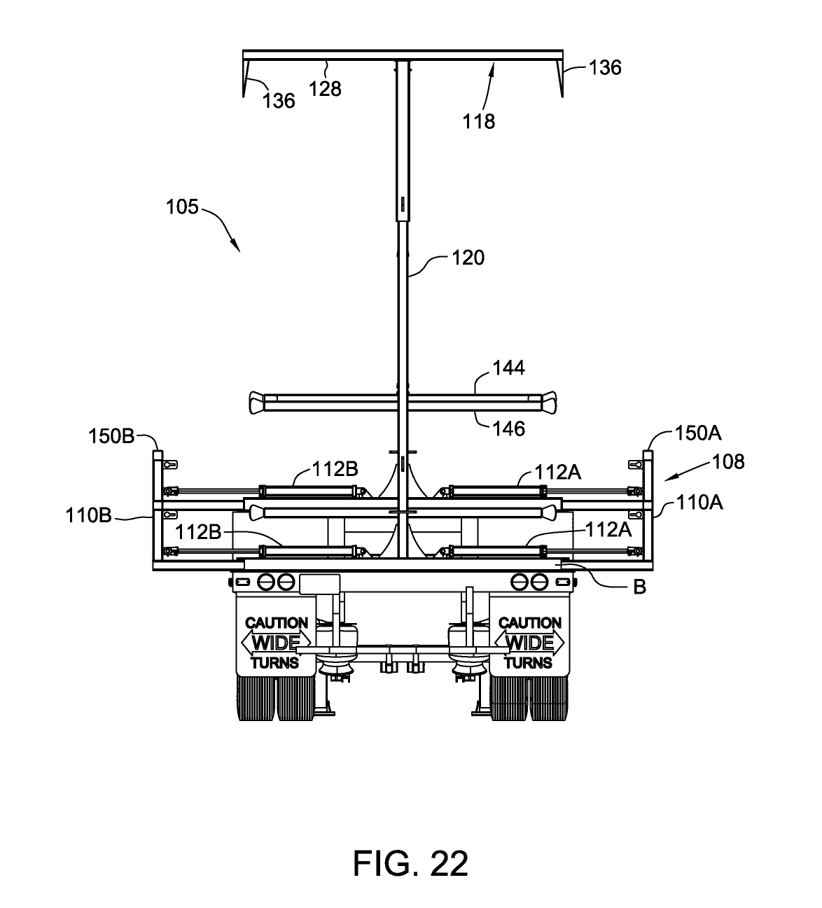

To load and secure bales on the bed deck B, the gate assembly 108 and retainer frame 118 of the apparatus 105 are extended to a loading position (FIGS. 21-22). In the loading position, the gates 110A, 110B are extended to increase the distance between the gates to facilitate loading of bales onto the bed deck B. Additionally, the retainer frame 118 is extended vertically from the bed deck B to increase the clearance between the retainer frame 118 and the top 150A, 150B of the gates 110A, 110B, over which the bales are loaded.

After bales are loaded in one or more rows on the bed deck B, the gates 110A, 110B are retracted by use of the gate assembly actuators 112A, 112B to a transport position (FIGS. 23-24). In the transport position, the gates 110A, 110B contain the bales to prevent them from moving side to side (i.e., in a direction transverse to the longitudinal axis). Additionally, the retainer frame 118 is lowered generally vertically by retracting the retainer frame actuators 140 such that the barbs 136 pierce the bale and/or the bale engaging faces 130A, 130B of the cross-members 128 contact the bales.

To unload bales, the gates 110A, 110B and retainer frame 118 are extended to an unloading position that generally corresponds to the loading position.

The apparatus 5 (FIGS. 1-13) and 105 (FIGS. 14-24) are suitable for securing bales of different sizes and shapes including, for example, round bales, small squares and large squares. The bales may be loaded in one or more rows and may be loaded side-by-side (e.g., two-wide, three-wide or more). The bottom row of bales may be secured in cradles (not shown) to prevent movement of the bales during transport and facilitate loading of bales. In embodiments in which the bales are round bales, the round bales may be loaded such that the longitudinal axis of the bales is transverse to the longitudinal axis of the apparatus. In embodiments in which two rows of bales are loaded onto the transport vehicle, generally the second row of bales are loaded directly on the bottom row (i.e., no cradles are used to support the second row).

As used herein, the term “attached” does not imply a direct connection between components and includes use of intermediate parts unless stated otherwise.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. An apparatus for containing bales on a transport vehicle, the transport vehicle comprising a bed deck and the apparatus having a longitudinal axis, the apparatus comprising:
a retainer frame including containment arms for extending between bales to contain movement of the bales in the direction of the longitudinal axis;
support legs that extend upward from the bed deck for supporting the retainer frame above the bed deck; and
a retainer frame actuator operatively connected to a support leg for raising the retainer frame for loading bales on the bed deck in one or more rows and thereafter lowering the frame to contain bales.

2. The apparatus as set forth in claim 1, wherein the retainer frame further comprises first and second elongate end members for containing movement of the bales in a direction transverse to the longitudinal axis.

3. The apparatus as set forth in claim 2, wherein the containment arms are operatively connected to the support legs, the support legs extending upward from a central portion of the bed deck.

4. The apparatus as set forth in claim 3, wherein the containment arms are pivotally connected to the support legs.

5. The apparatus as set forth in claim 3, further comprising containment arms not connected to the support legs.

6. The apparatus as set forth in claim 1, wherein the containment arms have a width sufficient to contain movement of the bales vertically.

7. The apparatus as set forth in claim 1 further comprising a gate assembly extending along the bed deck parallel to the longitudinal axis for containing the bales.

8. The apparatus as set forth in claim 7, wherein the gate assembly includes a first gate and a second gate positioned across the bed deck opposite the first gate, the first gate and second gate each comprising a first rail to brace bales against during loading and a second rail below the first rail to support bales during loading.

9. The apparatus as set forth in claim 1, wherein the apparatus comprises a plurality of modules for containing bales on the transport vehicle, each module comprising:
a retainer frame for independently containing movement of the bales in the direction of the longitudinal axis, the retainer frame comprising:
containment arms for extending between bales to contain movement of the bales in the direction of the longitudinal axis; and
first and second elongate end members for containing movement of the bales in a direction transverse to the longitudinal axis; and
a support leg that extends upward from the bed deck for supporting the retainer frame above the bed deck.

10. The apparatus as set forth in claim 9, wherein the apparatus is configured to contain bales on a drop-deck trailer having an upper deck and a lower deck, the apparatus including a first module sized to contain bales on the upper deck and a second module sized to contain bales on the lower deck.

11. The apparatus as set forth in claim 1 in combination with the bed deck.

12. The apparatus as set forth in claim 11, wherein the apparatus is removably attached to the bed deck.

13. The apparatus as set forth in claim 12, wherein the apparatus is attached to the bed deck with straps.

14. The apparatus as set forth in claim 11, wherein the bed deck forms part of a transport vehicle, the transport vehicle being selected from a trailer and a railcar.

15. A method for loading bales on a transport vehicle having a bed deck, the transport vehicle having a bale containment apparatus attached thereto, the bale containment apparatus having a longitudinal axis and comprising a retainer frame for containing movement of the bales along the longitudinal axis and support legs that extend upward from the bed deck for supporting the retainer frame above the bed deck, the method comprising:
raising the retainer frame to a loading position by increasing the distance between the retainer frame and the bed deck;
loading bales onto the bed deck; and
lowering the retainer frame to a travel position such that containment arms of the retainer frame extend between bales to contain movement of the bales along the longitudinal axis.

16. The method as set forth in claim 15, wherein an elongate end member of the retainer frame contains movement of the bales transverse to the longitudinal axis upon lowering the retainer frame.

17. The method as set forth in claim 15, wherein the apparatus further comprises a gate assembly extending along the bed deck parallel to the longitudinal axis, the method further comprising:
loading a bale over the gate assembly onto the bed deck with a loader; and
backing the loader away from the bed deck to cause the bale to contact the gate assembly to disengage the bale from the loader.

18. The method as set forth in claim 15, wherein the bales are round bales having a longitudinal axis, the round bales being loaded on the bed deck such that the longitudinal axis of the bales is transverse to the longitudinal axis of the apparatus.

19. The method as set forth in claim 15, wherein a bottom and a top row of bales are loaded onto the apparatus, the top row being loaded directly on the bottom row, the containment arms extending between bales of the top row.

20. The method as set forth in claim 15, wherein the retainer frame and gate assembly are removably attached to the transport vehicle.

21. The method as set forth in claim 20, wherein the apparatus comprises a plurality of modules for containing bales on the transport vehicle, each module comprising a retainer frame for containing movement of the bales along the longitudinal axis and a support leg that extends upward from the bed deck for supporting the retainer frame above the bed deck, the method comprising loading each module onto the bed deck and removably attaching the module to the bed deck.

22. An apparatus for securing bales on a transport vehicle, the transport vehicle comprising a bed deck and the apparatus having a longitudinal axis, the apparatus comprising:
a retainer frame for overlying and containing the bales;
support legs that extend upward from a central portion of the bed deck for supporting the retainer frame above the bed deck; and
a retainer frame actuator operatively connected to a support leg for raising the retainer frame for loading bales on the bed deck and thereafter lowering the frame to secure and contain the bales positioned on the bed deck.

23. The apparatus as set forth in claim 22, wherein the retainer frame comprises:
an elongate support member that extends parallel to the longitudinal axis; and
cross members that extend orthogonally from the support member, the cross members having a bale-engaging surface for engaging bales upon lowering the retainer frame.

24. The apparatus as set forth in claim 22 in combination with the bed deck, the apparatus being removably attached to the bed deck.

25. The apparatus as set forth in claim 22 further comprising:
a gate assembly extending along the bed deck parallel to the longitudinal axis for containing the bales; and
a gate assembly actuator operatively connected to the gate assembly for reducing a width of the gate assembly to secure and contain bales positioned on the bed deck.

26. A method for loading bales on a transport vehicle having a bed deck, the transport vehicle having a bale securing apparatus attached thereto, the bale securing apparatus having a longitudinal axis and comprising a retainer frame for overlying and containing the bales and support legs that extend upward from the bed deck for supporting the retainer frame above the bed deck, the method comprising:
raising the retainer frame generally vertically to a loading position by increasing the distance between the retainer frame and the bed deck;
loading bales onto the bed deck; and
lowering the retainer frame generally vertically to a travel position by decreasing the distance between the retainer frame and the bed deck to secure bales positioned on the bed deck.

27. The method as set forth in claim 26 wherein the apparatus further comprises a gate assembly extending along the bed deck parallel to the longitudinal axis, the method further comprising:
widening the gate assembly to a loading position; and
decreasing the width of the gate assembly to a travel position to secure bales loaded on the bed deck.

28. The method as set forth in claim 26, wherein the bales are round bales having a longitudinal axis, the round bales being loaded on the bed deck such that the longitudinal axis of the bales is transverse to the longitudinal axis of the apparatus.

29. The method as set forth in claim 26, wherein a bottom and a top row of bales are loaded onto the apparatus, the top row being loaded directly on the bottom row.
